(19) United States
(12) Patent Application Publication
(10) Pub. No.: US 2025/0095357 A1
(43) Pub. Date: Mar. 20, 2025

(54) HARDWARE ACCELERATOR, PROCESSOR, CHIP, AND ELECTRONIC DEVICE

(71) Applicant: Alibaba Innovation Private Limited, Singapore (SG)

(72) Inventors: Hao ZHANG, Shanghai (CN); Sicheng LI, Sunnyvale, CA (US); Jie JIAO, Shanghai (CN); Shusong XU, Shanghai (CN); Zihao LIU, Shanghai (CN); Yanheng LU, Shanghai (CN); Hu FAN, Shanghai (CN); Tao LIU, Shanghai (CN)

(21) Appl. No.: 18/830,854

(22) Filed: Sep. 11, 2024

(30) Foreign Application Priority Data
Sep. 15, 2023 (CN) 202311196499.3

(51) Int. Cl. G06V 10/94; G06F 7/50; G06F 7/523; G06V 10/82

(52) U.S. Cl. CPC G06V 10/955; G06F 7/50; G06F 7/523; G06V 10/82

(57) ABSTRACT

A hardware accelerator comprises a PE array, an internal buffer unit, and a data scheduler. The data scheduler obtains multiple image lines from the internal buffer unit and schedules the PE array to sequentially perform MAC (multiply-accumulate) operations on the multiple image lines. There are overlapping pixel lines between adjacent image lines, and the overlapping pixel lines are subjected to MAC operations in both of their adjacent image lines to which they belong. During the MAC operations on each image line, the PEs of the PE array are scheduled to perform MAC operations in tiles on multiple tiles included in each image line. For adjacent tiles, the operation result of the overlapping portion between the previous tile and the subsequent tile is cached, and combined with the operation result of the non-overlapping portion of the subsequent tile to form the MAC operation result of the subsequent tile.

### CROSS-REFERENCE TO RELATED APPLICATIONS

This application claims priority to Chinese Patent Application No. 202311196499.3, filed with the China National Intellectual Property Administration on Sep. 15, 2023, and entitled “Hardware Accelerator, Processor, Chip, and Electronic Device,” which is incorporated herein by reference in its entirety.

### TECHNICAL FIELD

The embodiments of the application relate to the field of hardware acceleration technology, and more specifically, to a hardware accelerator, processor, chip, and electronic device.

### BACKGROUND

Convolutional Neural Network (CNN) is one of the most important algorithms in deep learning. It is widely used in fields such as autonomous driving, computer vision, and speech recognition due to its high accuracy and low weight parameters. To efficiently deploy CNNs on terminal devices, the industry has developed corresponding neural network hardware accelerators for different neural networks.

Currently, most existing neural network hardware accelerators are used for classification tasks of CNNs. These accelerators process CNNs according to the sequential order of convolutional layers. In this processing method, feature data and weight data are loaded into the hardware accelerator's memory in different sequences for reuse. After completing the operation of one layer using off-chip memory, the operation of the next layer begins.

However, compared to CNNs used for classification tasks, image enhancement tasks do not frequently downsample images like feature maps. This results in a much higher volume of feature data and computational workload for image enhancement tasks when processing input images of the same size. Consequently, the frequent data interactions between the neural network hardware accelerator and off-chip memory lead to significant computational delays and increased processing power consumption.

### SUMMARY

In view of this, the present application provides a hardware acceleration scheme to at least partially address the aforementioned issues.

According to a first aspect of the embodiments of the present application, a hardware accelerator is provided, comprising: a processing element (PE) array, an internal buffer unit of the hardware accelerator, and a data scheduler configured between the PE array and the internal buffer unit. The data scheduler is configured to: sequentially obtain multiple image lines to be processed from the internal buffer unit, and schedule the PE array to sequentially perform multiply-accumulate (MAC) operations on the multiple image lines. There are overlapping pixel lines between adjacent image lines, and the overlapping pixel lines are subject to MAC operations in both of the adjacent image lines to which they belong. Additionally, during the MAC operations on each image line, the PE within the PE array that processes a current image line in tiles, is scheduled to perform MAC operations on multiple tiles included in each image line. For adjacent tiles, an operation result of the overlapping portion between a previous tile and a subsequent tile is cached and combined with the operation result of the non-overlapping portion of the subsequent tile to form a MAC operation result of the subsequent tile.

According to a second aspect of the embodiments of the present application, a processor is provided, comprising: the hardware accelerator as described in the first aspect.

According to a third aspect of the embodiments of the present application, a chip is provided, comprising: the processor as described in the second aspect.

According to a fourth aspect of the embodiments of the present application, an electronic device is provided, comprising: the chip as described in the third aspect.

According to a fourth aspect of the embodiments of the present application, a computer storage medium is provided, on which a computer program is stored. When executed by a processor, the program implements the method as described in the first aspect.

According to the scheme provided by the embodiments of the present application, a data scheduler is added to the hardware accelerator, which can be used for image enhancement tasks, to schedule data for MAC (multiply-accumulate) operations between the internal buffer unit of the hardware accelerator and the PE (processing element) array. In this scheduling, a line-input method is adopted, where the input image lines are longer in the X-dimension and shorter in the Y-dimension. During MAC operations, overlapping pixel lines between adjacent image lines in the Y-dimension are subjected to MAC operations (re-operation). For overlapping portions between tiles in the X-dimension, the operation result is buffered and immediately used in the next tile, i.e., the result of the overlapping portion from the previous tile is combined with the non-overlapping portion of the subsequent tile to form the MAC operation result of the subsequent tile. Thus, on the one hand, during operation, some data are re-computed while others are buffered, achieving a balance between on-chip buffer usage and re-operation of overlapping portions between tiles, thereby avoiding frequent read and write operations to off-chip memory (such as global buffer). On the other hand, performing MAC operations on a tile basis, except for the tiles on the left and right sides, fully utilizes the MAC operation capability of the PEs, avoiding the problem of reduced receptive field width layer by layer in a traditional pyramid integration data flow processing method, and preventing the decline in PE utilization. As a result, this approach fully utilizes the computational resources of the PEs while avoiding the computational delays and processing power consumption caused by frequent data interactions between the hardware accelerator and off-chip memory.

### BRIEF DESCRIPTION OF THE DRAWINGS

To more clearly illustrate the technical solutions in the embodiments of this application or the prior art, a brief description of the drawings required for the description of the embodiments or the prior art is provided below. It is evident that the accompanying drawings described below are merely some examples described in the embodiments of this application. For those skilled in the art, other drawings can also be obtained based on these drawings.

FIG. 1 is a schematic diagram of the structure of an exemplary hardware accelerator applicable to the embodiments of this application.

FIG. 2 is a schematic diagram of tiles of an image according to an embodiment of this application.

FIG. 3 is a schematic diagram of writing image lines to a global buffer using a sliding window method according to an embodiment of this application.

FIG. 4 is a schematic diagram of a tile processing process according to an embodiment of this application.

FIG. 5 is a schematic diagram of an inter-block data scheduling process of a tile according to an embodiment of this application.

FIG. 6 is a schematic diagram of a MAC operation processing process according to an embodiment of this application.

FIG. 7 is a schematic diagram of the relationship between weight data and image data/feature data during the MAC operation processing according to an embodiment of this application.

FIG. 8 is a structural block diagram of a processor according to an embodiment of this application.

FIG. 9 is a structural block diagram of a chip according to an embodiment of this application.

FIG. 10 is a schematic diagram of the structure of an electronic device according to an embodiment of this application.

### DETAIL DESCRIPTION OF THE EMBODIMENTS

To enable those skilled in the art to better understand the technical solutions in the embodiments of this application, the technical solutions in the embodiments of this application will be clearly and completely described below in conjunction with the accompanying drawings. It is evident that the described embodiments are merely part of the embodiments of this application, not all of them. Based on the embodiments in this application, all other embodiments obtained by those of ordinary skill in the art shall fall within the scope of protection of the embodiments of this application.

The specific implementation of the embodiments of this application will be further explained below in conjunction with the accompanying drawings of the embodiments.

The hardware accelerator can achieve acceleration for various operations, such as convolution operations. Since convolution operations can be widely applied to tasks like classification and image processing-related tasks, the hardware accelerator can also be broadly applied to these tasks where convolution operations are applicable. In this example, the hardware accelerator can be used for image enhancement tasks, leveraging the characteristics of large data volume and high computational load associated with image enhancement tasks to achieve hardware acceleration. It should be noted that this is not limited to image enhancement tasks; other convolution operation tasks with large data volumes and high computational loads are also applicable to the scheme of the embodiments of this application.

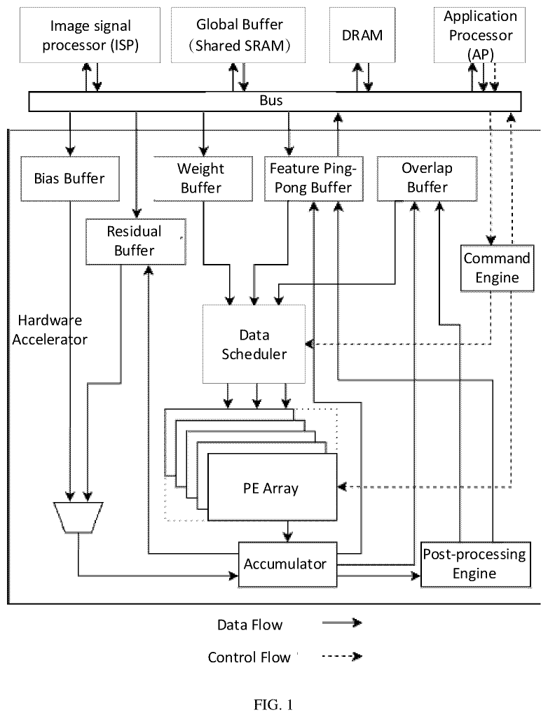

The hardware accelerator provided by the embodiments of this application will be explained in conjunction with FIG. 1 below. FIG. 1 illustrates an exemplary hardware accelerator applicable to the scheme of this application. As shown in FIG. 1, the hardware accelerator interacts with other devices through a bus, such as the Image Signal Processor (ISP), Application Processor (AP), Dynamic Random Access Memory (DRAM), and Static Random-Access Memory (SRAM), which in this example is shared SRAM, serving as the global buffer interfacing with the hardware accelerator. In this example, a data scheduler is added inside the hardware accelerator, located between the internal buffer unit of the hardware accelerator (including but not limited to the weight buffer, feature ping-pong buffer, and overlap buffer) and the PE array of the hardware accelerator. This data scheduler can efficiently support the input and output of the image sensor (not shown) and/or the ISP. In one feasible approach, the ISP scans the image in raster scan order by pixel lines, inputting and outputting pixel lines, with multiple pixel lines forming an image line. This enhances the efficiency of image data input and output. On this basis, the data scheduler can control the scheduling of image lines between the global buffer interfaced with the hardware accelerator, internal buffer unit (weight buffer, feature ping-pong buffer, overlap buffer), and the PE array, using tiles as units for inter-chunk and intra-chunk data scheduling, completing the layer fusion data flow.

Additionally, as shown in FIG. 1, the internal buffer unit of the hardware accelerator can also include a bias buffer for caching biases generated during convolution operations and a residual buffer for caching residuals generated during convolution operations. However, it should be noted that, based on the computational characteristics of convolution operations, the data scheduler in this example primarily schedules data based on the weight buffer, feature ping-pong buffer, and overlap buffer.

As shown in FIG. 1, for a given image (either an input image or a convolved feature map), the data scheduler in this example continuously retrieves data from the weight buffer, feature ping-pong buffer, and overlap buffer based on the instructions from a command engine within the hardware accelerator. It then schedules the PEs in the PE array to perform the corresponding MAC operations based on the retrieved data until all the image data of that image has been fully processed. The results processed by the PEs are then combined with the biases and residuals corresponding to that image, which are buffered in the bias buffer and residual buffer, respectively. These combined results are input into an accumulator within the hardware accelerator for further processing. Subsequently, the processed results are transmitted to a post-processing engine of the hardware accelerator for predefined post-processing, resulting in the convolution processing outcome for that image.

In the aforementioned process, the global buffer is used for data interaction between the ISP and the hardware accelerator. The ISP writes pixel lines in raster scan order, eventually forming image lines, and writes them back as image lines after the hardware accelerator completes the operation. The input and output data of the Feature Ping-Pong Buffer are tiles created after tiling the image lines. To handle the overlapping portions generated after tiling the tiles, the overlap buffer buffers the operation result of the right boundary overlapping portions between tiles for each layer.

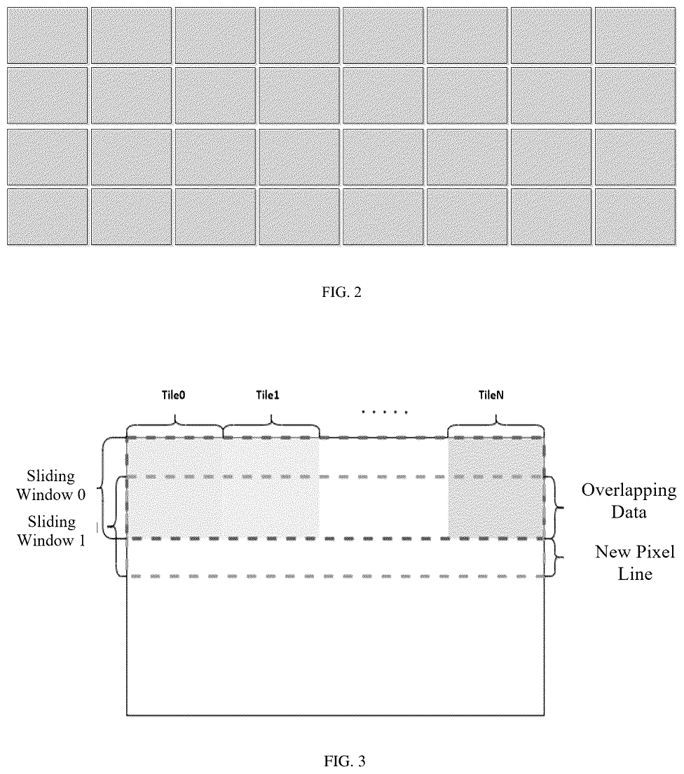

Tiling refers to dividing the input image/feature map along the X-dimension (horizontal dimension) and Y-dimension (vertical dimension). An illustration of tiling is shown in FIG. 2. In FIG. 2, the entire image (input image or feature map) is divided into 4×8 tiles. During a scheduling process by the data scheduler, the feature ping-pong buffer loads one tile at a time, which is then scheduled by the data scheduler to the PEs in the PE array for processing. In practical applications, this tiling operation is performed by the data scheduler when it determines that at least one complete image line has been buffered in the global buffer, rather than pre-processing the image. In this embodiment, each PE in the PE array is used for a single MAC operation, including a multiplier and an adder to perform the MAC operation.

Based on the hardware accelerator structure shown in FIG. 1, the hardware acceleration scheme of this application will be explained through the following examples.

The hardware accelerator provided in this embodiment at least includes: a PE array, an internal buffer unit of the hardware accelerator, and a data scheduler configured between the PE array and the internal buffer unit.

The data scheduler is used to: sequentially obtain multiple image lines to be processed from the internal buffer unit and schedule the PE array to sequentially perform MAC operations on the multiple image lines. There are overlapping pixel lines between adjacent image lines, and these overlapping pixel lines are subjected to MAC operations in both of the adjacent image lines to which they belong. During the MAC operations on each image line, the data scheduler schedules the PEs in the PE array to process a current image line in tiles, performing MAC operations on multiple tiles included in each image line. For adjacent tiles, the operation result of the overlapping portion from the previous tile is buffered and combined with the operation result of the non-overlapping portion of the subsequent tile to form the MAC operation result of the subsequent tile.

From a macroscopic perspective, the hardware accelerator performs related processing, such as image enhancement processing, on an image basis. However, on a slightly more microscopic level, the hardware accelerator in the embodiments of this application processes the image on an image line basis. Exemplarily, as shown in FIG. 2, the image is divided into 4 image lines. It should be noted that an image line is a unit of image processing, typically comprising multiple pixel lines. In traditional methods, processing one image line at a time and then loading and processing a new image line can cause interruptions in loading and processing, thereby affecting processing efficiency. Therefore, the embodiments of this application adopt a sliding window approach to load image lines. In this method, the sliding window moves with a certain step size, usually in unit of pixel lines, resulting in overlapping pixel line portions between the image lines formed by two sliding windows. On a more microscopic level, when the PE array performs specific computational processing, each PE processes separately, with each PE performing operations in unit of tiles within an image line. Specifically, in this embodiment, each PE can be considered to have a multiplier-accumulator (MAC) unit for processing tiles. The MAC unit performs MAC operations on the tile, while other processing can be handled by other portions of the PE, which is not restricted in this embodiment. As shown in FIG. 2, it includes 4 image lines, each containing 8 tiles. Based on the nature of convolution operations using a convolution kernel, successive convolution operations may involve redundant operations on the boundary portions of adjacent tiles. Typically, this involves data at the boundary of the previous tile adjacent to the subsequent tile. Therefore, by processing the overlapping pixel line portions and the redundantly computed boundary portions of tiles, the hardware accelerator can enhance the overall speed and efficiency of image enhancement processing, achieving the effect of hardware acceleration.

Specifically, in the embodiments, the ISP writes pixel lines to the global buffer in a raster scan order to form image lines. The hardware accelerator interfaces with the global buffer, thus obtaining multiple image lines written in raster scan order from the global buffer. This facilitates line-priority input and processing of the image. Consequently, due to the raster scan order, the width of the image lines is much greater than their length. In practical applications, the data scheduler can start scheduling data upon recognizing that enough pixel lines (e.g., 10-30 pixel lines) are available to form at least one image line. The number of pixel lines can be parameterized so that after MAC operations, at least one image line output is obtained as the minimum value.

After caching a complete image line, the data scheduler segments the buffer image line in the global buffer to obtain multiple tiles corresponding to the image line. This segmentation of the image line is referred to as the tiling operation. The tiling operation divides the image line along the X-dimension to ensure that each tile obtained from the segmentation precisely fills the PE processing the current image line in the X-dimension direction, thereby maximizing the utilization of the PE. The number of tiling operations can be parameterized to fully utilize the PE resources, matching the data volume of the tile that the PE can handle. Therefore, the size of the tile can be configured by those skilled in the art according to actual circumstances, making the solution of this embodiment adaptable to various tile sizes. After the tiling operation is completed, the data scheduler schedules the feature ping-pong buffer to load the first tile for dispatch to an available PE for MAC operations. Once the PE completes the operation for an image line, the output or operation result is written back to the global buffer. Initially, this tiling operation is performed on the image lines of the input image. In subsequent processes, the tiling operation will be performed on the feature map obtained after convolution.

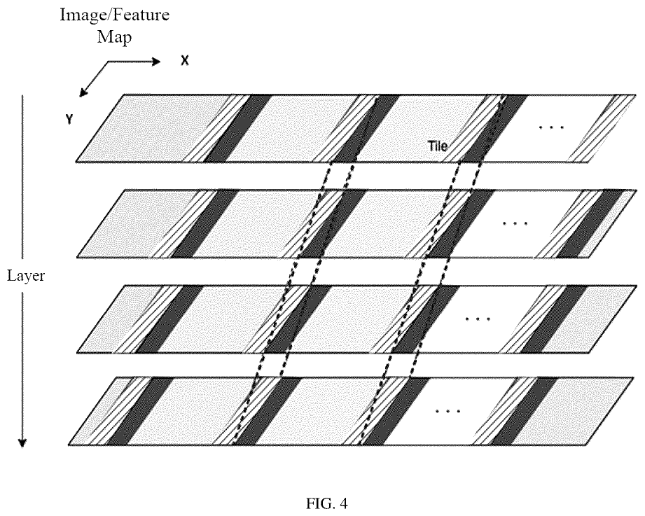

To facilitate input, a sliding window method can be used to write image lines to the global buffer. Exemplarily, as shown in FIG. 3, the upper dashed box illustrates the first image line written to the global buffer using the sliding window method. For ease of distinction, this image line data is represented by window 0 in FIG. 3. The sliding window moves with a preset step size. In FIG. 3, the second image line written to the global buffer by the sliding window is shown in the lower dashed box. For ease of distinction, this image line data is represented by window 1 in FIG. 3. It is evident that the image lines corresponding to window 0 and window 1 contain some overlapping data, i.e., partially overlapping pixel lines. These overlapping pixel lines are computed during the MAC operations for both the image line corresponding to window 0 and the image line corresponding to window 1. In other words, the overlapping pixel lines between adjacent image lines undergo MAC operations in both of the adjacent image lines to which they belong. Thus, for the tile processing that ultimately operates on a tile basis, the overlapping portions of the tile in the X-dimension are handled by re-operation. This approach reduces the demand for on-chip buffer and avoids the high power consumption caused by frequent interactions between on-chip and off-chip buffers.

In a feasible approach, the internal buffer unit at least includes an image data unit used for caching image lines in tiles, as exemplified by the feature ping-pong buffer shown in FIG. 1. In this case, the data scheduler sequentially obtains multiple image lines to be processed from the internal buffer unit by sequentially retrieving the tiles corresponding to each image line from the image data unit. This approach effectively utilizes the existing structure of the hardware accelerator, enabling further hardware acceleration with minimal modifications to the hardware accelerator.

For example, after completing the tiling operation for a certain image line, the data scheduler will schedule the feature ping-pong buffer to load the first tile of that image line and schedule it to the PE for operation. At the same time, the feature ping-pong buffer will continue to load the other tiles of that image line in sequence. The processing of a tile by the PE can be considered as a single convolution operation of the convolution kernel. Because the convolution kernel moves with a certain stride during the convolution of the image, there is an overlap in data between two consecutive convolutions. The amount of overlapping data can be determined specifically based on the size of the convolution kernel and the stride of the convolution kernel. Specifically, in this example, after the PE performs the MAC operation on the previous tile, it caches the result of the MAC operation of the overlapping portion with the next tile for use in the MAC operation of the next tile.

When the internal buffer unit includes an overlap buffer unit, the process of caching the operation results of the overlapping portion between adjacent tiles can be implemented as follows: based on the stride of the convolution kernel, determine the overlapping portion of the adjacent tiles. During the MAC operations on each tile by the PE, the MAC operation results of the overlapping portion are buffered in the overlap buffer unit. Exemplarily, this overlap buffer unit can be the overlap buffer, as shown in FIG. 1. This approach ensures that the overlapping data between tiles is efficiently reused, reducing redundant operations and enhancing the overall performance of the hardware accelerator.

An example of the above process is shown in FIG. 4, which illustrates the MAC operation processing for 4 image lines. For each image line, as depicted in FIG. 4, each PE processes data in unit of tiles. Taking the first image line as an example, the first tile of this line has a right boundary portion (indicated by the slashed area) that overlaps with the second tile. The MAC operation result for this overlapping portion is cached in the overlap buffer. When the PE processes the second Tile, it reads the cached data from the overlap buffer as part of the MAC operation result for the second tile, as shown by the gray portion on the left boundary of the second tile in FIG. 4. Meanwhile, the right boundary of the second tile (also shown as a slashed area) overlaps with the third tile. After obtaining the MAC operation result for this overlapping portion, this result is cached in the overlap buffer for use in the MAC operations for the third tile, as indicated by the gray portion on the left boundary of the third tile in FIG. 4. This process continues in a similar manner until the last tile of the current image line. Thus, all tiles corresponding to the image line in the global buffer are processed, resulting in the complete MAC operation result for that image line. Subsequently, this result is cached in the global buffer and then output to the ISP for the next level of processing.

It should be noted that while the PE is performing the tile processing of an image line, the image line reading operation from the external global buffer and the image line caching operation in the image data unit are also being carried out simultaneously. Therefore, the data scheduler will also retrieve newly cached image lines (in unit of tiles) from the internal buffer unit while scheduling the PE to perform MAC operations on the image line. These newly cached image lines have overlapping pixel lines with the previously cached image lines (as shown in the overlapping portion between window 0 and window 1 in FIG. 3). As previously mentioned, these overlapping pixel lines are included in the MAC operations in both the previously cached image line and the newly cached image line. For example, this is illustrated by the gray portions on the far left of the second to fourth image lines in FIG. 4. This parallel execution of different operations further enhances the speed and efficiency of the hardware accelerator in performing image processing tasks, such as image enhancement.

In a specific implementation, while performing MAC operations on an image line, the overlapping pixel lines from the previously cached image line can be cached in the registers of the PE array for use in the MAC operations of the newly cached image line. Specifically, the overlapping pixel lines cached in the registers are also cached in unit of tiles. Because the overlapping pixel lines are divided into multiple parts corresponding to the tiles based on the tiling method, and since the PE processes data in unit of tiles, the portions of the overlapping pixel lines cached in the registers correspond to the tiles currently being processed by the PE. By using this approach, two main benefits are achieved: it reduces the amount of on-chip cache required. It allows the cached data in the registers to be applied more quickly to the processing of the next image line. This method ensures efficient utilization of the PE array and accelerates the overall image processing, further enhancing the performance of the hardware accelerator in tasks such as image enhancement.

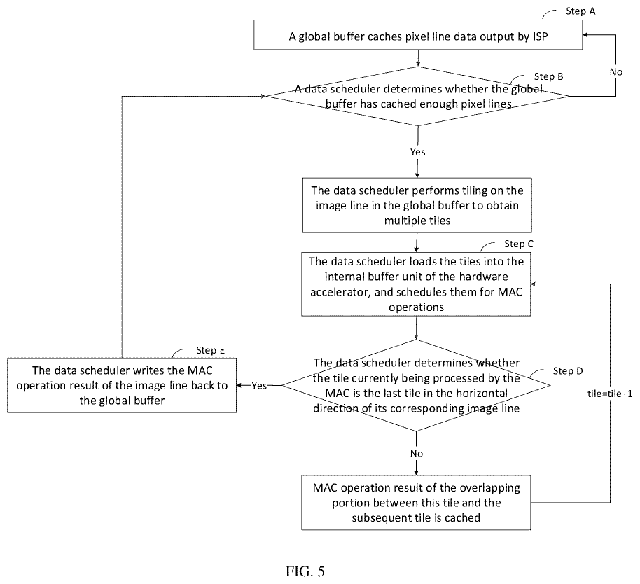

An example of the inter-tile data scheduling process based on tiles is illustrated in FIG. 5. The process may include the following steps:

Step A: a global buffer caches pixel line data output by ISP.

Step B: a data scheduler determines whether the global buffer has cached enough pixel lines to form at least one complete image line. If so, after forming the image line, the data scheduler performs tiling on the image line in the global buffer to obtain multiple tiles. If not, returns to Step A.

Wherein, a sufficient number of lines can be exemplarily 10-30 lines.

Step C: the data scheduler loads the tiles into the internal buffer unit of the hardware accelerator (specifically, the image Feature Ping-Pong Buffer), and schedules them to a PE for operation.

The operation process is as described above and will not be repeated here.

Step D: the data scheduler determines whether the tile currently being processed by the PE is the last tile in the horizontal direction of its corresponding image line. If not, a MAC operation result of the overlapping portion (right boundary) between this tile and the subsequent tile is cached. Then, the tile counter is incremented by 1 (tile=tile+1), and it returns to Step C. If it is the last tile, proceed to Step E.

Step E: the data scheduler writes the MAC operation result of the image line back to the global buffer and returns to Step B.

It can be seen that, in the scheme provided by the embodiments of this application, the hardware accelerator can support image lines input and output in raster scan order, and can accommodate different tile size selections. By combining the aforementioned inter-tile data scheduling for tiles, the data scheduler ensures a balance between on-chip caching and the re-operation of overlapping portions between tiles. This approach guarantees high MAC utilization and prioritized line input/output, effectively addressing the frequent off-chip memory read/write issues encountered by hardware accelerators in computational imaging tasks. Moreover, due to the line-priority approach, where the X-dimension of the input image line is longer, the data scheduler adopts a re-operation strategy for the overlapping portions between tiles in the X-dimension. For the shorter Y-dimension overlapping portions between tiles, the data scheduler caches the overlapping data layer by layer and immediately uses this data in the next tile's operation. This method reduces the re-operation workload with a smaller on-chip buffer and solves the problem of reduced receptive field width in the traditional pyramid layer fusion data flow method. Except for the tiles on the left and right edges, this approach maintains the high utilization of operation units. In the traditional pyramid layer fusion data flow method, as the depth of the neural network increases, the size of the feature map gradually decreases, and the data mapped to the hardware accelerator's PEs also decreases, leading to a decline in PE utilization. Additionally, the overlapping portions of the feature map between different pyramid layers result in significant re-operation. The method described in this application effectively avoids these problems.

In summary, according to the scheme provided by the embodiments of this application, a data scheduler is added to the hardware accelerator used for image enhancement tasks. This data scheduler facilitates MAC (multiply-accumulate) operation processing by scheduling data between the internal buffer unit and the PE array of the hardware accelerator. The scheduling process uses a line-input method, making the input image lines longer in the X-dimension and shorter in the Y-dimension. During MAC operations, for overlapping pixel lines between adjacent image lines in the Y-dimension, a re-operation strategy is employed. For overlapping portions between tiles in the X-dimension, the results are cached and immediately used in the next tile. This means combining the non-overlapping portion's operation results of the next tile with the cached overlapping portion's results to form the MAC operation result for the next tile. From this, on one hand, during operation, some data is re-computed while some is cached. This balances between on-chip caching and re-operation of overlapping portions between tiles and reduces the need for frequent read and write operations to off-chip memory (such as an global buffer). One the other hand, performing MAC operations on a tile basis, except for the tiles on the left and right edges, fully utilizes the computational capabilities of the PE array. This avoids the issue of reduced receptive field width encountered in traditional pyramid layer integration data flow methods, preventing a decline in PE utilization. As a result, the scheme not only fully utilizes the computational resources of the PE array but also avoids the computational delays and power consumption caused by frequent data interactions between the hardware accelerator and off-chip memory.

To further enhance the data processing efficiency of the hardware accelerator, improvements can be made to the PE array. In one feasible approach, the PE array can be partitioned into sub-arrays based on a current convolution kernel size, managed by the data scheduler. Optionally, the sub-array partitioning of the PE array can be done along the height direction. For example, sub-arrays can be grouped with heights of 1/3/5/7/9, and the feature data and weight data can be organized and input into the PE array accordingly. The height of the PE array should be a multiple of 30, while the width can be a configurable parameter.

Based on the sub-array partitioning of the PE array, the data scheduler schedules the PE array to sequentially perform MAC operations on multiple image lines, which can be implemented as follows: according to the size of the convolution kernel, the PE array is divided into sub-arrays in the height direction to obtain multiple line groups; the PE array is scheduled to sequentially perform MAC operations on multiple image lines through multiple line groups. This ensures that MAC resources are fully utilized and parallel operation is enabled, further improving computational efficiency. Furthermore, scheduling the PE array to sequentially perform MAC operations on multiple image lines through multiple line groups includes: for each image line, scheduling the PE array through multiple line groups to obtain the weight line group data corresponding to the image line; based on the weight line group data, performing MAC operations on the image line to obtain the corresponding image feature data.

Since the hardware accelerator adopts the form of a PE Array, it can be further partitioned in the height direction to form multiple sub-arrays. Each sub-array can be considered a line group, and a line group can process multiple tiles of an image line at a time. This further improves the resource utilization rate of the PE array and enhances the overall efficiency of image processing. Additionally, in convolution operations, each image line corresponds to respective weights, and the weights for each tile in the image line are the same as the weights of its corresponding image line. When the PE array is partitioned into line groups, computational processing can be performed upon obtaining the input image data/feature data (tiles) and the corresponding weight data for the image data/feature data. In the embodiments of this application, the “/” can indicate an “or” relationship.

In a feasible approach, when the internal buffer unit includes a weight buffer unit (such as the weight buffer shown in FIG. 1), the weight data is cached in this weight buffer unit. The data scheduler can group the buffered weight data in the weight buffer unit by lines according to the size of the convolution kernel to obtain multiple sets of weight line group data. Correspondingly, for each image line, when the data scheduler schedules the PE array through multiple line groups to obtain the weight line group data corresponding to the image line, this weight group data is obtained from the multiple sets of weight line group data buffer in the weight buffer unit.

Based on this, performing MAC operations on image lines based on the weight line group data can be implemented as follows: schedule the input of weight line group data into multiple line groups of the PE array along the line direction, and schedule the input of image line tiles into multiple line groups of the PE array along the diagonal direction. Perform MAC operations on the image line based on the inputs from the multiple line groups.

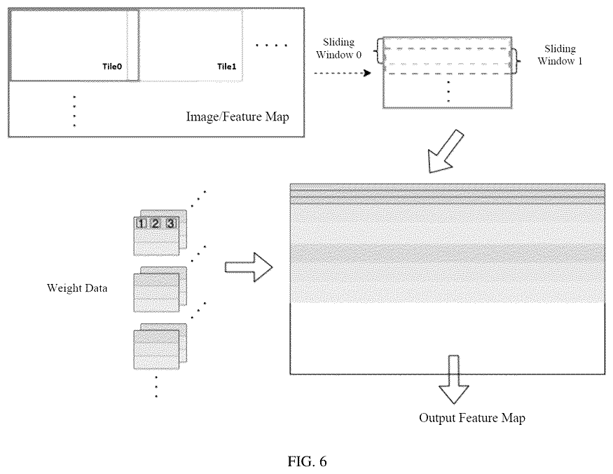

An exemplary process of performing MAC operations on image lines through multiple line groups of the PE array is shown in FIG. 6.

In the example shown in FIG. 6, the data scheduler groups the convolution kernel in the line direction to form multiple convolution lines. After forming multiple convolution lines, the weight data input each time corresponds to the weight line group data, and the input image data/feature data is the data in the sliding window corresponding to the weight data on the input image/feature map. Furthermore, the data scheduler schedules the weight data to be input along the line direction of the line groups, while the data in the sliding window is input along the diagonal direction, and the partial sums are accumulated along the column direction to obtain the corresponding results.

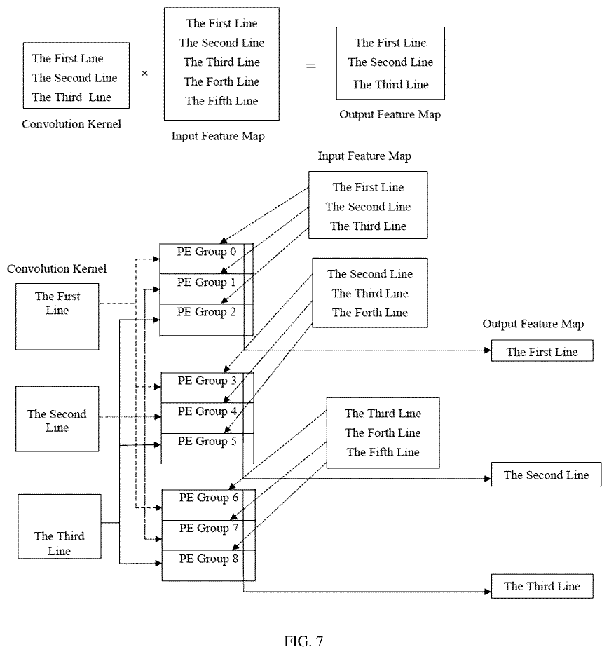

An exemplary correspondence between weight data and image data/feature data is shown in FIG. 7. In FIG. 7, the convolution kernel is exemplified as a 3×3 convolution kernel, and the image/feature map to be processed is exemplified as an input feature map including 5 image lines. Using this convolution kernel to perform convolution on the input feature map will result in a 3×3 output feature map.

When using the convolution kernel to perform convolution on the first to third lines of the input feature map, the first to third lines of the input feature map use the weight data corresponding to the first line of the convolution kernel. Specifically, the first to third lines of the input feature map are processed by the first line group of the PE array, which includes “PE Group 0,” “PE Group 1,” and “PE Group 2,” with each group containing at least one PE. Specifically, the first line of the input feature map is processed by “PE Group 0,” the second line by “PE Group 1,” and the third line by “PE Group 2.” After processing, the first line of the output feature map is generated.

Similarly, when using the convolution kernel to perform convolution on the second to fourth lines of the input feature map, the second to fourth lines of the input feature map use the weight data corresponding to the second line of the convolution kernel. Specifically, the second to fourth lines of the input feature map are processed by the second line group of the PE array, which includes “PE Group 3,” “PE Group 4,” and “PE Group 5,” with each group containing at least one PE. Specifically, the second line of the input feature map is processed by “PE Group 3,” the third line by “PE Group 4,” and the fourth line by “PE Group 5.” After processing, the second line of the output feature map is generated.

When using the convolution kernel to perform convolution on the third to fifth lines of the input feature map, the third to fifth lines of the input feature map use the weight data corresponding to the third line of the convolution kernel. Specifically, the third to fifth lines of the input feature map are processed by the third line group of the PE array, which includes “PE Group 6,” “PE Group 7,” and “PE Group 8,” with each group containing at least one PE. Specifically, the third line of the input feature map is processed by “PE Group 6,” the fourth line by “PE Group 7,” and the fifth line by “PE Group 8.” After processing, the third line of the output feature map is generated.

It should be noted that the feature data to be processed can be input in the diagonal direction formed by multiple line groups. For example, in FIG. 7, the second line of the input feature map is input in the diagonal direction to “PE Group 1” and “PE Group 3”; the third line of the input feature map is input in the diagonal direction to “PE Group 2,” “PE Group 4,” and “PE Group 6”; and the fourth line of the input feature map is input in the diagonal direction to “PE Group 5” and “PE Group 7.” Moreover, each line group performs MAC operations in parallel. This effectively enhances the efficiency of the MAC operation processing.

After the operation of an image line (including multiple tiles) corresponding to one sliding window is completed, the obtained feature data is fixed, and the data scheduler schedules a new set of weight data for operation until all weight data is exhausted. For overlapping pixel lines between image lines, specifically in tile processing, the overlapping data portions of different sliding windows within a tile will not be repeatedly scheduled but will be stored in the registers of the PE array and reused internally within the PE array.

Through the aforementioned processing, different convolution dimensions can be flexibly mapped onto the line groups of the PE array. By combining the processing data flow of each line group of the PE array for image lines with the full reuse of input data, the access to on-chip and off-chip memory during the convolution operation can be effectively optimized. This ensures high utilization of the PE array for any workload.

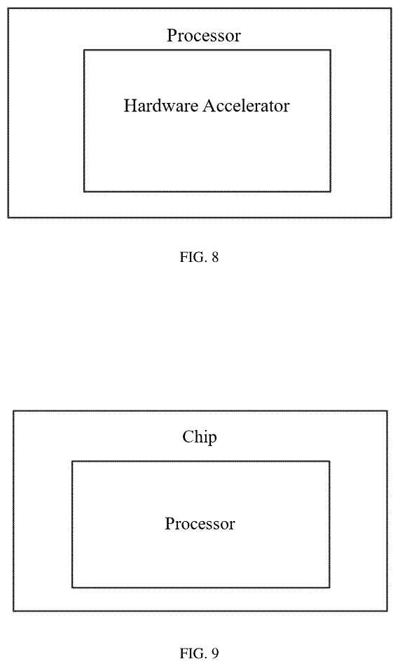

Based on the above hardware accelerator, the present application also provides a processor. FIG. 8 shows a structural block diagram of this processor. As shown in FIG. 8, the processor may include the hardware accelerator described above.

In one feasible approach, the hardware accelerator is a neural network hardware accelerator.

Additionally, in another feasible approach, the processor can be implemented as an NPU (Neural Processing Unit).

Furthermore, the embodiments of the present application also provides a chip. FIG. 9 shows a structural block diagram of this chip. As shown in FIG. 9, the chip may include the processor described above, such as the aforementioned NPU.

Furthermore, the embodiments of the present application also provides an electronic device that may include the chip described above.

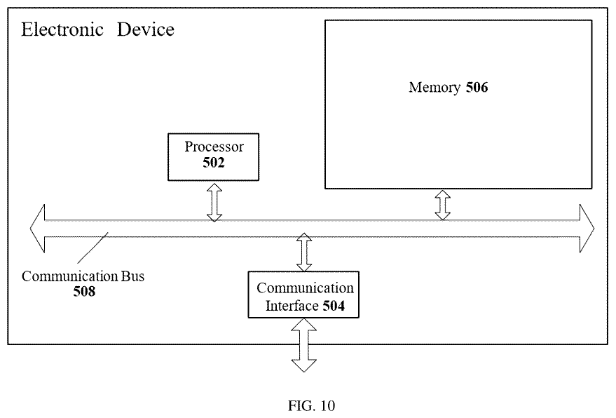

As a specific example, FIG. 10 shows a schematic diagram of the structure of an electronic device. The specific embodiments of this application do not limit the specific implementation of the electronic device.

As shown in FIG. 10, the electronic device may include: a chip 502 (e.g., processor), a communications interface 504, a memory 506, and a communication bus 508. Specifically:

the chip 502, communications interface 504, and memory 506 communicate with each other through the communication bus 508. The communications interface 504 is used for communication with other electronic devices or servers;

the chip 502 is the chip described above, equipped with a hardware accelerator that can provide hardware acceleration for image processing, such as image enhancement processing;

the chip 502 may be an NPU, capable of independently performing related processing or forming a heterogeneous system with a CPU and other components to perform tasks related to image processing, especially image enhancement processing;

the memory 506 is used to store programs and data required for the operation of applications within the electronic device. The memory 506 may include high-speed RAM and may also include non-volatile memory, such as at least one disk storage device.

The specific process of achieving the corresponding functions of the electronic device through the chip 502 can refer to the descriptions in the aforementioned embodiments and has corresponding beneficial effects, which will not be repeated here.

Through the scheme of the present application embodiments, a data scheduler is added to the hardware accelerator. This data scheduler can support data input and output in raster scan order. Combined with the inter-block data scheduling when the PE processes data in tiles, it can support different tile sizes. The data scheduler ensures a balance between on-chip caching and the re-operation of overlapping portions between tiles, under the premise of prioritizing line input and output and maintaining high PE utilization. This resolves the issue of frequent off-chip memory reads and writes when the hardware accelerator performs computational imaging tasks. Furthermore, due to the line-priority feature, where the image lines and their corresponding tiles are longer in the X-dimension direction, the data scheduler adopts a re-operation strategy for overlapping data in the Y-dimension direction between tiles. For the shorter overlap in the X-dimension direction between tiles, the data scheduler buffer the overlapping portions layer by layer and immediately uses this data in the next tile operation. This reduces the amount of re-operation with a smaller on-chip buffer and addresses the problem of reduced receptive field width in the pyramid layer fusion data stream. Therefore, except for the tiles on the left and right sides, there will be no issue of decreased PE utilization. Combined with the PE's intra-block data scheduling for tiles, it flexibly maps different convolution dimensions onto the PE array. Through the optimized fixed-line data flow and full reuse of input feature data, it maximizes the optimization of on-chip and off-chip memory access during the convolution operation and ensures high PE utilization for any workload.

It should be noted that, according to implementation needs, each component/step described in the embodiments of this application can be divided into more components/steps. Similarly, two or more components/steps or parts of the operations of components/steps can be combined into new components/steps to achieve the objectives of the embodiments of this application.

The above embodiments are merely illustrative of the embodiments of this application and are not intended to limit them. Various changes and modifications can be made by those skilled in the relevant technical field without departing from the spirit and scope of the embodiments of this application. Therefore, all equivalent technical solutions also fall within the scope of the embodiments of this application. The scope of patent protection for the embodiments of this application should be defined by the claims.

What is claimed is:

1. A hardware accelerator, comprising: a processing element (PE) array, an internal buffer unit of the hardware accelerator, and a data scheduler between the PE array and the internal buffer unit;
wherein the data scheduler is configured to:
sequentially obtain multiple image lines to be processed from the internal buffer unit, and schedule the PE array to sequentially perform multiply-accumulate (MAC) operations on the multiple image lines, wherein overlapping pixel lines between adjacent image lines are subjected to MAC operations in both of the adjacent image lines to which they belong; and
during the MAC operations on each image line, schedule the PE within the PE array that processes a current image line in tiles, to perform MAC operations on multiple tiles included in each image line, wherein for adjacent tiles, an operation result of the overlapping portion between a previous tile and a subsequent tile is cached, and combined with the operation result of the non-overlapping portion of the subsequent tile to form a MAC operation result of the subsequent tile.

2. The hardware accelerator according to claim 1, wherein the hardware accelerator is interfaced with a global buffer to obtain the multiple image lines written in a raster scan order through the global buffer.

3. The hardware accelerator according to claim 2, wherein the data scheduler is further configured to segment the image lines that have been cached in the global buffer to obtain multiple tiles corresponding to each image line.

4. The hardware accelerator according to claim 1, wherein the internal buffer unit at least includes an image data unit, the image data unit being configured to cache tiles of image lines in unit of tiles;
wherein to sequentially obtain the multiple image lines to be processed from the internal buffer unit, the data scheduler is configured to sequentially obtain the tiles corresponding to each image line from the image data unit.

5. The hardware accelerator according to claim 4, wherein the internal buffer unit further includes an overlapping buffer unit;
wherein for adjacent tiles, the data scheduler is configured to determine the overlapping portion of adjacent tiles according to a stride of a convolution kernel; and cache the MAC operation result of the overlapping portion in the overlapping buffer unit when performing MAC operations on each tile by the PE.

6. The hardware accelerator according to claim 1, wherein the data scheduler is further configured to, while scheduling the PE array to perform MAC operations on the multiple image lines sequentially, obtain a newly cached image line from the internal buffer unit, wherein overlapping pixel lines between the newly cached image lines and a previously cached image line are included in MAC operations in both the previously cached image line and the newly cached image line.

7. The hardware accelerator according to claim 6, wherein, when performing MAC operations on the image lines, the overlapping pixel lines in the previously cached image line are cached into registers of the PE array for use in the MAC operations of the newly cached image line.

8. The hardware accelerator according to claim 1, wherein to schedule the PE array to sequentially perform multiply-accumulate (MAC) operations on the multiple image lines, the data scheduler is configured to:
divide the PE array into sub-arrays in a height direction according to a size of a convolution kernel to obtain multiple line groups;
schedule the PE array to perform MAC operations on the multiple image lines sequentially through the multiple line groups.

9. The hardware accelerator according to claim 8, wherein to schedule the PE array to perform MAC operations on the multiple image lines sequentially through the multiple line groups, the data scheduler is configured to:
for each image line, obtain weight line group data corresponding to the image line through the multiple line groups;
perform MAC operations on the image line based on the weight line group data to obtain corresponding image feature data.

10. The hardware accelerator according to claim 9, wherein the internal buffer unit further comprises a weight buffer unit;
and wherein the data scheduler is further configured to group weight data buffered in the weight buffer unit by lines according to the size of the convolution kernel to obtain multiple sets of weight line group data.

11. The hardware accelerator according to claim 9, wherein to perform MAC operations on the image line based on the weight line group data, the data scheduler is configured to:
schedule the weight line group data to be input into the multiple line groups of the PE array along a line direction, and schedule the tiles of the image line to be input into the multiple line groups of the PE array along a diagonal direction;
perform MAC operations on the image line based on the inputs of the multiple line groups.

12. A processor, comprising the hardware accelerator according to claim 1.

13. An image processing method comprising:
obtaining, by a data scheduler, multiple image lines to be processed from a buffer unit;
scheduling a processing element (PE) array to sequentially perform multiply-accumulate (MAC) operations on the multiple image lines, wherein overlapping pixel lines between adjacent image lines are subjected to MAC operations in both of the adjacent image lines to which they belong;
during the MAC operations on each image line, scheduling the PE within the PE array that processes an image line to perform MAC operations in unit of tiles on the image line, wherein for adjacent tiles, an operation result of the overlapping portion between a previous tile and a subsequent tile is cached, and combined with the operation result of the non-overlapping portion of the subsequent tile to form a MAC operation result of the subsequent tile.

14. The method according to claim 13, wherein obtaining the multiple image lines to be processed from a buffer unit comprises obtaining tiles corresponding to each image line from the buffer unit.

15. The method according to claim 14, further comprising:
determining the overlapping portion of adjacent tiles according to a stride of a convolution kernel; and
caching the MAC operation result of the overlapping portion when performing MAC operations on each tile by the PE.

16. The method according to claim 13, wherein scheduling the PE array to sequentially perform MAC operations on the multiple image lines comprises:
dividing the PE array into sub-arrays in a height direction according to a size of a convolution kernel to obtain multiple line groups;
scheduling the PE array to perform MAC operations on the multiple image lines sequentially through the multiple line groups.

17. The method according to claim 16, wherein scheduling the PE array to perform MAC operations on the multiple image lines sequentially through the multiple line groups comprises:
for each image line, obtaining weight line group data corresponding to the image line through the multiple line groups;
performing MAC operations on the image line based on the weight line group data to obtain corresponding image feature data.

18. The method according to claim 17, wherein performing MAC operations on the image line based on the weight line group data comprises:
scheduling the weight line group data to be input into the multiple line groups of the PE array along a line direction, and scheduling the tiles of the image line to be input into the multiple line groups of the PE array along a diagonal direction;
performing MAC operations on the image line based on the inputs of the multiple line groups.
